(19) United States
(12) Patent Application Publication
(10) Pub. No.: US 2008/0305021 A1
(43) Pub. Date: Dec. 11, 2008

(54) Conditioners for the Enhancement of Mercury Removal from Combustion Gases by Various Sorbents

(76) Inventor: Rabindra K. Sinha, McKees Rocks, PA (US)

Correspondence Address: RABINDRA K. SINHA, 609 HANCOCK COURT, MCKEES ROCKS, PA, 15136, US

(21) Appl. No.: 11/759,812

(22) Filed: Jun. 7, 2007

(51) Int. Cl. B01D 53/14

(52) U.S. Cl. 423/234

(57) ABSTRACT

The present invention provides a method for lowering the rate of injection of activated carbon or carbon based sorbents for control of mercury in coal fired utility systems where the flue gas is also conditioned with SO3 or SO3/NH3 conditioning. The invention replaces the SO3 or SO3/NH3 conditioning by a water based conditioner which does not much adversely affect the efficiency of the injected activated carbon. One such water based conditioner is a composition contained in ATI-2001 available from ARKAY Technologies Inc., 609 Hancock Court, McKees Rocks, Pa. 15136.

### BACKGROUND OF THE INVENTION

This invention relates to improving the performance of activated carbon and other sorbent that needs to be injected for controlling the emissions of mercury from the flue gases. It is specifically utilized on boiler systems fitted with electrostatic precipitators. It can more specifically be utilized where flue gas is conditioned with sulfur trioxide.

Environmental considerations require that emissions of hazardous pollutants such as mercury be controlled. Most US coals and municipal refuge contain mercury in them which is released into atmosphere as elemental and oxidized mercury together with the combustion gases, also known as flue gas. Unless the mercury is removed from the fuel prior to its combustion, it becomes extremely difficult to remove mercury effectively and economically once it becomes a part of the flue gas. Some judicious segregation of municipal refuge is helpful in removing mercury from municipal refuge prior to its combustion but its removal from coal is also very challenging. One of the technologies for removing (controlling) mercury emission is to inject a suitable sorbent (that absorbs mercury) in the combustion gases. Activated carbon, halogenated activated carbon and various other sorbents that are capable of removing mercury by sorption is a technology of choice for mercury control. Activated Carbons is utilized in here to represent any and all modified and unmodified carbons.

Coal (a term utilized in here to describe solid fuels such as bituminous and sub-bituminous coals, anthracite, lignite and peat) is one of the most important fuels for producing power. It is burned in boilers all over the world to produce steam and electrical power. Power plants in the USA are estimated to burn more than one billion tons of coal a year.

Coals contain many impurities including ash, sulfur, mercury, arsenic, selenium, beryllium, boron, etc. When coal is burned in a furnace it is converted to carbon dioxide and water producing heat. The impurity such as ash remains behind as a residue while the majority of other impurities such as sulfur, mercury, arsenic, etc. leave with the combustion gases.

Depending upon the firing practices utilized, the ash is removed as bottom ash or as a combination of bottom and fly ash. The fly ash is that portion of the ash that becomes entrained in the combustion gases and moves around with them into the various parts of the boiler or combustion systems. Since the ash is entrained with the combustion gases, it is removed from the combustion gases before the gases are discharged into the atmosphere through chimneys or stacks. The separation of the entrained or the fly ash from the combustion gases is accomplished by utilizing particulate control devices such as cyclones, electrostatic precipitators, bag houses or their combinations.

Emissions of mercury from power plants, though minuscule in mass compared to ash and oxides of sulfur and nitrogen commonly referred to SOx and NOx, are targeted for control due to its tendency to bio-accumulate, and its potency as a neurotoxin.

The mercury is emitted from the stacks with the combustion gases in the form of elemental and oxidized mercury. The ratio between the elemental and the oxidized forms depends upon the type of the coal being burned and the equipment it is burned in. The ratio of the oxidized and the un-oxidized (elemental) form of mercury when burning bituminous or eastern coals is higher than when burning sub-bituminous or western coals. The higher ratio when burning bituminous coals is believed due to the presence of a higher level of chlorides in the bituminous than sub-bituminous coals.

Many novel and unique methods are currently being evaluated to control the emission of mercury from the stack gases. Most of the processes require injection of a mercury specific sorbent(s) into the combustion gas stream. The sorbent is injected prior to the particulate control device(s) so that the sorbent containing the adsorbed mercury is removed by the particulate control device(s) together with the fly ash.

Among the sorbents tried have been powdered activated carbon, various chars, clays, zeolites, different types of fly ash, fly ash enriched with unburned carbon, etc. However, in the USA, as it is practiced commercially in the countries of Europe and Asia, powdered activated carbon is one of the most effective sorbents for mercury removal. The powder activated carbon is blown in by compressed air into the combustion gases upstream of the particulate control device at gas temperatures between 250 and 800° F. In the case of cold side electrostatic precipitators and bag houses the temperatures range between 250 and 400° F. The hot side electrostatic precipitators operate around 800° F. The powder carbon works best when the gas temperatures are low and for that reason even in the coldside precipitator applications, sometimes, the flue gases are cooled by injecting a fine spray of water.

Sometimes, the carbon is specially modified by adding sulfur, halogens such as iodine and bromine, etc., to make it more suitable and active to remove mercury. This is known as introducing special specificity to the activated carbon. Such specificity is introduced in the carbon either during its manufacturing or as a separate step after the carbon has been manufactured.

The ineffectiveness of carbon at high temperatures requiring gas cooling and introduction of specificity to the carbon adds to the overall cost of mercury removal. In addition, the costs of commercial carbons are a major factor in keeping the mercury removal costs unacceptable.

As mentioned before the ash known as fly ash is removed from the combustion gases by various equipment. There are two most accepted equipment—the Electro Static Precipitator (ESP) and the Bag House. The efficiencies of the ESP depend on coal properties, equipment condition and gas temperatures. With time and changing coal qualities, the efficiency of the ESP must be increased for acceptable level of ash removal from the gas stream. This is generally accomplished by conditioning the flue gas.

Gas conditioning is practiced by many US and European coal burning utilities which also must install technologies for mercury removal. There are two well recognized techniques for gas conditioning—SO3 and/or SO3—NH3 injection and proprietary chemical injection. The goal of both technologies is to lower (modify) the electrical resistivity of the fly ash so that it can be collected more effectively in the ESP box.

In systems where the fly ash is conditioned with SO3 or SO3/NH3, the activated carbon injection (ACI) to remove mercury concurrently with particulates in the ESP becomes much less effective. In other words a much larger amount of carbon must be injected to obtain mercury removals similar to when no SO3 or SO3/NH3 conditioning is used.

This invention relates to minimizing the adverse effects of SO3 or SO3/NH3 conditioning on the performance of ACI for mercury removal. The minimization of adverse effects of SO3 or SO3/NH3 conditioning is brought by injecting a water based chemical (to condition the gas) instead. With water based chemical injection, conditioning of the ash (for the intended improved collection of the treated ash in the ESP) is accomplished without adversely affecting the performance of the co-injected activated carbon (or other desired sorbent) to remove the mercury.

### SUMMARY OF THE INVENTION

This invention relates to minimizing the adverse effects of SO3 or SO3/NH3 conditioning on the performance of activated carbon and other sorbents used for mercury removal from flue gases. The adverse effects can be minimized when the ash is conditioned by injecting a water based chemical instead of SO3 or SO3/NH3 (for the improved collection of the treated ash in the ESP). Conditioning the ash with water based chemical (such as ATI-2001, available from ARKAY Technologies, 609 Hancock Ct., Mckees Rocks, Pa. 15136) instead of with SO3 or SO3/NH3 minimizes the potential of adversely affecting the capacity of mercury removal by the injected sorbent. Utilization of water based conditioners as invented here can thus help keep the overall cost of mercury control similar to systems where no SO3 or SO3/NH3 conditioning is utilized. The savings brought about by this invention to industries can be substantial.

### DETAILED DESCRIPTION OF THE INVENTION

ESP has been a technology of choice for industries to control emissions of fine particulates for a long time. This has been particularly a device of preference for coal fired utilities. Since its operation for particulate collection depends on certain electrical properties, such as restivities of the fly ash must remain in a certain range for acceptable level of collection, all coals cannot use the same size ESP. In addition, gas temperature, its moisture content and the cohesive properties of the ash fines must also remain within a certain range for a given ESP to perform at its design.

Since the properties of coal change from one coal seam to another and from region to region, designing a perfect ESP for a given power generating station is a moving target. A given ESP therefore needs help from time to time and when the fuel characteristics change drastically. For these reasons one either must condition the fly ash, design a bigger ESP or select an altogether different technology such as bag house to meet the regulatory limits on the emission of fine particulates.

The most common conditioning agent is by dispersing SO3 gas into the flue gas. The SO3 is brought into the flue gas from an external source. It is produced by catalytically oxidizing SO2 on site. The SO2 is either brought to the plant and stored or is produced by burning sulfur in special burners. The popularity of SO3 conditioning is due to various factors. It's more or less universally applicable to many different types of coals in the US. It was also introduced at a time when the need for gas conditioning was direly needed because of fuel switching from high sulfur to low sulfur coals by the utilities. The SO3 technology utilizing sulfur burners on site also provided the monetary incentive as it was capital intense but low on operating cost.

It is now well established by EPA, EPRI and DOE conducted full system tests that those utilities which have SO3 or SO3/NH3 conditioning will have to incur extra cost should they utilize ACI as the technology of choice for mercury control. Several test data have shown that the carbon sorbent use rate has to be increased 2× to 10× to achieve the similar levels of mercury control.

Utilizing the water based conditioners such as ATI-2001 available from ARKAY Tech, 609 Hancock Court, McKees Rocks, Pa. 15136, instead of SO3 or SO3/NH3 the ACI rate can be kept similar to non-SO3 or SO3/NH3 conditioned ESP-Flue Gas systems. Switching to water based conditioners thus can lower the mercury removal cost by a large margin. The utilities can thus benefit by switching to water based conditioners for flue gas conditioning and ACI and other sorbents for mercury control.

### REFERENCES CITED

Published Patent Applications (up to Jun. 4, 2007):
Search Topic: “Mercury Control”;
Application Numbers: 20070051239; 20060228270; 20040076557; 20030161771; 20020102189;
Search Topic: “Mercury control with Activated Carbon and SO3”: 0 applications

US Patent Documents

| | | | |
|---|---|---|---|
| 6,447,740 | September, 2002 | Caldwell, et al. | 423/210 |
| 6,439,138 | August, 2002 | Teller, et al. | 110/345 |
| 6,375,909 | April, 2002 | Dangtran, et al. | 423/235 |
| 6,372,187 | April, 2002 | Madden, et al. | 422/171 |
| 6,258,334 | July, 2001 | Gadkaree, et al. | 423/210 |
| 5,879,948 | March, 1999 | Van Pelt | 436/81 |
| 5,854,948 | December, 1998 | Chang, et al. | 502/417 |
| 5,672,323 | September, 1997 | Bhat, et al. | 422/172 |
| 5,505,766 | April, 1996 | Chang, et al. | 502/417 |
| 5,409,522 | April, 1995 | Durham, et al. | 75/670 |

### OTHER REFERENCES

1. Sinha, R. K. and Walker, P. L. Jr., “Removal of Mercury by Sulfurized Carbons”, Carbon, Volume 10, 1972
2. Vidic, R. D. and McLaughlin, J. D., “Uptake of Elemental Mercury by Activated Carbons”, Journal of A&WMA, Volume 46, March 1996
3. Mercury Study Report to Congress, EPA-452/R-97-010, Volume VIII; “An Evaluation of Mercury Control Technologies and Costs”, December 1997
4. Ghorishi, S. B., Singer, C. F., Jozewicz, W. S., Sedman, C., and Srivastava, R. K., “Simultaneous Control of Mercury, SO2, and NOx by Novel Oxidized Calcium-Based Sorbents”, Journal of A&WMA, Volume 52, March 2002
5. Chang, R and Offen, G. R., “Mercury Emissions Control Technologies: An EPRI Synopsis, Power Engineering, November 1995, pp 51-57
6. Sjostrom, S., Ebner, T., Harrington, P., Sly, R., and Chang, R., “Field Studies of Mercury Control Using Injected Sorbents”, A&WMA Annual Meeting, Session Ae-1b, 2002
7. Department of Energy (DOE)-National Energy Technolgy Laboratory (NETL) web site: www.netl.doe.gov/coalpower/environment/mercury for small and large field testing info.
8. 10^{th} Annual Electric Utilities Environmental Conference (EUEC), Jan. 21-24, 2007, The Westin La Paloma, Tucson, Ariz.
9. DOE-NETL's Experience with Activated Carbon Injection in High SO3 Environments, Lynn A. Brickett, National Energy Technology Laboratory.
10. The Effects of SO3 and ESP Size on Activated Carbon Injection, Katherine Dombrowski, URS Corporation, Austin, Tex.

What is claimed is:

1. A method to improve the performance of activated carbon and other sorbents for mercury control by conditioning the flue gas with water based gas conditioners.

2. The method according to claim 1 above where the water based conditioner is utilized in place of SO3 or SO3/NH3 gas conditioning.

3. The method according to claim 1 above where the water based conditioner is similar in composition to as formulated in ATI-2001 available from ARKAY Tech.
